(19) United States
(12) Patent Application Publication
(10) Pub. No.: US 2024/0011855 A1
(43) Pub. Date: Jan. 11, 2024

(54) PRESSURE SENSOR

(71) Applicants: UNIVERSITY OF LIMERICK, Limerick (IE); TECHNOLOGICAL UNIVERSITY DUBLIN, Dublin (IE)

(72) Inventors: Gabriel LEEN, Cork (IE); Fintan MCGUINNESS, Lifford (IE); Muhammad Mahmood ALI, Limerick (IE); Elfed LEWIS, O'Brien's Bridge (IE); Mohamed OUBAHA, Dublin (IE)

(21) Appl. No.: 18/247,159

(22) PCT Filed: Sep. 28, 2021
(86) PCT No.: PCT/EP2021/076595

§ 371 Date: Mar. 29, 2023

(30) Foreign Application Priority Data
Sep. 29, 2020 (GB) 2015363.1

(51) Int. Cl. G01L 9/00

(52) U.S. Cl. CPC G01L 9/0042; G01L 9/0079

(57) ABSTRACT

The present invention relates to a diaphragm for a pressure sensor, the diaphragm comprising a hybrid sol-gel film. The invention also extends to a process for the manufacture of said diaphragm for a pressure sensor and to a pressure sensor comprising said diaphragm.

### FIELD

The present invention relates to a diaphragm for a pressure sensor, a pressure sensor comprising said diaphragm, and a method of manufacturing a pressure sensor. In particular, the present invention relates to a pressure sensor of the extrinsic Fabry-Perot interferometric type, a diaphragm for an extrinsic Fabry-Perot interferometric pressure sensor, and a method of manufacturing a diaphragm for an extrinsic Fabry-Perot interferometric pressure sensor.

### BACKGROUND

Extrinsic Fabry-Perot interferometric (EFPI) pressure sensors are widely used for the monitoring of pressure and acoustic waves, in particular in industrial and biomedical applications. It is the sensitivity and compact shape of EFPI pressure sensors that make them especially useful in biomedical applications. Furthermore, EFPI pressure sensors exhibit a high-frequency response, are not affected by electromagnetic interference, and can provide high data rates at remote locations due to their ability to be multiplexed in large numbers on one single fibre.

A typical EFPI pressure sensor comprises an optical fibre, a diaphragm and a wall defining an air-filled cavity between the end face of the optical fibre and the diaphragm. The diaphragm is typically formed of glass. Differences in pressure between the inside of the cavity, on a first side of diaphragm, and external to the cavity, on a second side of the diaphragm, causes the diaphragm to deflect. The deflection of the diaphragm alters the length of the cavity between the diaphragm and the optical fibre end face, and the change of length can be measured by optical methods.

Incident light that propagates through the optical fibre may travel through the cavity and be reflected by the inside and outside surfaces of the diaphragm. The reflected light may propagate through the optical fibre and generate interference fringes. The measured interference fringes may indicate the length of the cavity, and so the change in length of the cavity caused by the deflection of the diaphragm can be determined. The pressure difference can be determined based on the change in length of the cavity.

Existing methods for manufacturing EFPI pressure sensors can be time consuming, which can limit the scalability of manufacture of EFPI pressure sensors. In particular, the diaphragm of the EFPI pressure sensor is a critical element of the EFPI pressure sensor and is difficult to manufacture. To improve sensitivity in pressure measurements, it is desirable to provide a very thin diaphragm, for example with a thickness of less than 10 microns. Existing methods for fabricating such a thin diaphragm can be time consuming.

An existing method for manufacturing an EFPI pressure sensor comprises fusing a silica glass fibre to a first end of a glass capillary and inserting an optical fibre into a second end of the glass capillary. The space between the optical fibre and the silica glass fibre within the glass capillary forms the cavity for the pressure sensor. The optical fibre is fused to the capillary such that the end face of the optical fibre is a predetermined distance from the inner end face of the silica glass fibre, thereby providing the cavity with a predetermined length. To fabricate the glass diaphragm, the outer end of the silica glass fibre is polished manually to a predetermined thickness and then etched, for example using hydrofluoric acid. A glass diaphragm manufactured in this way may have a thickness of 5-6 microns.

The polishing step is very time consuming and requires a highly skilled operator. A sensor may be easily damaged during the polishing step due to the manual nature of the process. Hydrofluoric acid can be a dangerous material to work with and so the etching process may also require a highly skilled operator. Furthermore, the sensor may be easily damaged during the etching step, due to over-etching, or the hydrofluoric acid perforating the diaphragm, forming holes in the diaphragm.

### SUMMARY

According to a first aspect of the present invention there is provided a diaphragm for a pressure sensor, the diaphragm comprising a hybrid sol-gel film.

Advantageously, a diaphragm comprising a hybrid sol-gel film is easier to manufacture than a typical glass diaphragm, for example. Advantageously, the use of a hybrid sol-gel film, rather than a non-hybrid sol-gel film, for example, results in a hybrid sol-gel film having a good balance of physical and chemical properties which means it is suitable for use as a diaphragm in a pressure sensor.

By “diaphragm”, and like terms as used herein, is meant a thin disc (or membrane) that is suitable for use in a pressure sensor and, thus, which is able to deflect under pressure.

The diaphragm comprises a hybrid sol-gel film. For the avoidance of doubt, by “hybrid sol-gel”, and like terms, as used herein is meant a sol-gel formed from at least one inorganic component and at least one organic component. The inorganic component and the organic component may be part of the same compound or may be separate compounds. For example, the inorganic component may be in the form of a metal atom and the organic component may be in the form of, for example, an alkyl group (or any other organic moiety) chemically bonded thereto.

The hybrid sol-gel film is suitably derived from a hybrid sol-gel composition. The hybrid sol-gel may be formed from any suitable components. The hybrid sol-gel composition may be formed from at least one metal alkoxide precursor. The hybrid sol-gel may be formed from at least one organosilane precursor. The hybrid sol-gel composition may be formed from at least one metal alkoxide precursor and at least one organosilane precursor.

The metal alkoxide precursor may comprise any suitable metal alkoxide. Suitable metal alkoxides will be known to a person skilled in the art. The metal alkoxide may be of formula M(OR)ₓ, wherein M is a metal atom, each R is independently an alkyl group, such as a C₁-C₁₂ alkyl group, such as a C₁-C₄ alkyl group, or even propyl or butyl, and X is the valence of the metal atom, M. The metal atom, M, may be any suitable atom. Examples of suitable metal atoms, M, include, but are not limited to, zirconium (Zr), titanium (Ti), tantalum (Ta), niobium (Nb), germanium (Ge), tin (Sn) and cerium (Ce).

Suitably, the metal atom may comprise zirconium (Zr), titanium (Ti), tantalum (Ta), niobium (Nb) or combinations thereof. More suitably, the metal atom may comprise zirconium (Zr), titanium (Ti) or combinations thereof. Most suitably, the metal atom may comprise zirconium (Zr)

Suitably, the metal may comprise zirconium and each R may comprise propyl or butyl. Thus, suitably, the metal alkoxide precursor may comprise zirconium butoxide (Zr(OBu)₄) and/or zirconium propoxide (Zr(OPr)₄). Suitably, the metal alkoxide may comprise zirconium propoxide (Zr(OPr)₄).

Suitably, the metal may comprise titanium and each R may comprise propyl, such as isopropyl. Thus, suitably, the metal alkoxide precursor may comprise titanium propoxide, such as titanium isopropoxide (Ti[OCH(CH₃)₂]₄).

Suitably, the metal alkoxide precursor may comprise zirconium butoxide (Zr(OBu)₄), zirconium propoxide (Zr(OPr)₄), titanium isopropoxide (Ti[OCH(CH₃)₂]₄) or combinations thereof. More suitably, the metal alkoxide precursor may comprise zirconium propoxide (Zr(OPr)₄), titanium isopropoxide (Ti[OCH(CH₃)₂]₄) or combinations thereof.

The metal alkoxide may be organically modified. For the avoidance of doubt, when the metal alkoxide is organically modified the resultant compound (or organically modified metal alkoxide precursor) will suitably have organic functionality, such as non-hydrolysable organic functionality, bound to the inorganic group.

Thus suitably, the metal alkoxide may be of formula M(OR)_{X-n}(R′)ₙ, wherein M is a metal atom, each R is independently an alkyl group, such as a C₁-C₁₂ alkyl group, such as a C₁-C₄ alkyl group, or even propyl or butyl, each R′ is independently an organic group, X is the valence of the metal atom, M, and n is from 1 to X−1 (X minus 1).

R′ is an organic group. Suitable organic groups include, but are not limited to those derived from pivalic acid, acetic acid, (alk)acrylic acid, alkyl(alk)acylate or combinations thereof. Examples of suitable (alk)acrylic acids include, but are not limited to (C₁-C₁₂ alk)acrylic acid, C₁-C₁₂ alkyl(C₁-C₁₂ alk)acylate or combinations thereof, such as (C₁-C₆ alk)acrylic acid, C₁-C₆ alkyl(C₁-C₆ alk)acylate or combinations thereof, such as such as (C₁-C₄ alk)acrylic acid, C₁-C₄ alkyl(C₁-C₄ alk)acylate or combinations thereof, such as (C₁-C₃ alk)acrylic acid, C₁-C₃ alkyl(C₁-C₃ alk)acylate or combinations thereof, or even methacrylic acid. Advantageously, the use of an organically modified metal alkoxide precursor may result in a hybrid sol-gel which has improved flexibility, increased connectivity and increased lifetime.

Suitably, the organic group, R′, may be derived from pivalic acid, acetic acid, methacrylic acid or combinations thereof. More suitably, the organic group, R′, may be derived from methacrylic acid.

Thus, the metal alkoxide precursor may be of formula M(OR)ₓ and/or formula M(OR)ₓ₋ₙ(R′)ₙ, wherein each of M, R, X, R¹ and n are as defined herein.

Suitably, when the metal alkoxide is of formula M(OR)_{X-n}(R′)ₙ, the metal may comprise zirconium or titanium, each R may independently comprise propyl or butyl, each R′ may independently comprise an organic group, X may be 4 and n may be from 1 to 3.

Advantageously, the use of an organically modified metal alkoxide precursor allows control of the rate of hydrolysis of the metal alkoxide during formation of the hybrid sol-gel composition. For example, the organic group, R′, may displace two (2) of the alkoxide groups of the metal alkoxide, thus blocking these sites to hydrolysis. For example, when the group, R′, is derived from methacrylic acid, the oxygen atoms of the carboxylic acid group of the methacrylic acid may bond to the metal atom, displacing two (2) of the alkoxide groups of the metal alkoxide.

The organosilane precursor may comprise any suitable organosilane material. Suitable organosilane materials will be known to a person skilled in the art. Suitably, the organosilane material may comprise a silicon alkoxide. Thus, suitably, the organosilane material may be of formula R¹_{4-X}Si(OR²)ₓ, wherein each R¹ is independently a substituted or unsubstituted alkyl, alkenyl or alkynyl group, such as a substituted or unsubstituted C₁-C₁₂ alkyl group, substituted or unsubstituted C₁-C₁₂ alkenyl group or substituted or unsubstituted C₁-C₁₂ alkynyl group, each R² is independently an alkyl group, such as a C₁-C₁₂ alkyl group, such as a C₁-C₆ alkyl group, such as a C₁-C₄ alkyl group, or even a C₁-C₃ alkyl group, and X is 1-4.

Suitably, each R¹ may independently be a substituted alkenyl group, such as a substituted C₁-C₁₂ alkenyl group, such as a substituted C₁-C₆ alkenyl group.

Suitably, each R¹ may independently be substituted with one or more oxygen atom.

Suitably, each R¹ may independently be substituted with one or more amine group.

Suitably, each R¹ may independently be an (alk)acryloxy(alkyl)-group, such as a (C₁-C₁₂ alk)acryloxy(C₁-C₁₂ alkyl)-group, such as a (C₁-C₆ alk)acryloxy(C₁-C₆ alkyl)-group, such as a (C₁-C₄ alk)acryloxy(C₁-C₄ alkyl)-group, such as a (C₁-C₃ alk)acryloxy(C₁-C₃ alkyl)-group, or even methacryloxypropyl.

Suitably, each R¹ may independently be an alkylamine group, such as a C₁-C₁₂ alkylamine group, such as a C₁-C₆ alkylamine group, such as a C₁-C₄ alkylamine group, such as a C₁-C₃ alkylamine group, or even propylamine.

Suitably, each R² may be methyl, ethyl or propyl, such as methyl or ethyl, or even methyl.

Suitably, X may be 3 or 4. More suitably, X may be 3.

Suitably, the organosilane precursor may comprise methacryloxypropyltrimethoxysilane (MAPTMS), tetraethyl orthosilicate (TEOS), triethoxysilylpropylamine (APTES) or combinations thereof. More suitably, the organosilane precursor may comprise methacryloxypropyltrimethoxysilane (MAPTMS), triethoxysilylpropylamine (APTES) or combinations thereof. Most suitably, the organosilane precursor may comprise methacryloxypropyltrimethoxysilane (MAPTMS)

The term “alk” or “alkyl”, as used herein unless otherwise defined, relates to saturated hydrocarbon radicals being straight, branched, cyclic or polycyclic moieties or combinations thereof and contain 1 to 20 carbon atoms, such as 1 to 10 carbon atoms, such as 1 to 8 carbon atoms, such as 1 to 6 carbon atoms, or even 1 to 4 carbon atoms. These radicals may be optionally substituted with a hydroxyl, epoxy, chloro, bromo, iodo, cyano, nitro, mercapto, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from methyl, ethyl, n-propyl, isopropyl, n-butyl, isobutyl, sec-butyl, tert-butyl, 2-methylbutyl, pentyl, iso-amyl, hexyl, cyclohexyl, 3-methylpentyl, octyl and the like. The term “alkylene”, as used herein, relates to a bivalent radical alkyl group as defined above. For example, an alkyl group such as methyl which would be represented as —CH₃, becomes methylene, —CH₂—, when represented as an alkylene. Other alkylene groups should be understood accordingly.

The term “alkenyl”, as used herein, relates to hydrocarbon radicals having, such as up to 4, double bonds, being straight, branched, cyclic or polycyclic moieties or combinations thereof and containing from 2 to 18 carbon atoms, such as 2 to 10 carbon atoms, such as from 2 to 8 carbon atoms, such as 2 to 6 carbon atoms, or even 2 to 4 carbon atoms. These radicals may be optionally substituted with a hydroxyl, epoxy, chloro, bromo, iodo, cyano, nitro, mercapto, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from alkenyl groups include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like. The term “alkenylene”, as used herein, relates to a bivalent radical alkenyl group as defined above. For example, an alkenyl group such as ethenyl which would be represented as —CH═CH₂, becomes ethylene, —CH═CH—, when represented as an alkenylene. Other alkenylene groups should be understood accordingly.

The term “alkynyl”, as used herein, relates to hydrocarbon radicals having, such as up to 4, triple bonds, being straight, branched, cyclic or polycyclic moieties or combinations thereof and having from 2 to 18 carbon atoms, such as 2 to 10 carbon atoms, such as from 2 to 8 carbon atoms, such as from 2 to 6 carbon atoms, or even from 2 to 4 carbon atoms. These radicals may be optionally substituted with a hydroxy, epoxy, chloro, bromo, iodo, cyano, nitro, mercapto, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or lower alkyl, and/or be interrupted by oxygen or sulphur atoms, or by silano or dialkylsiloxane groups. Examples of such radicals may be independently selected from alkynyl radicals include ethynyl, propynyl, propargyl, butynyl, pentynyl, hexynyl and the like. The term “alkynylene”, as used herein, relates to a bivalent radical alkynyl group as defined above. For example, an alkynyl group such as ethynyl which would be represented as —C≡CH, becomes ethynylene, —C═C—, when represented as an alkynylene. Other alkynylene groups should be understood accordingly.

The term “aryl” as used herein, relates to an organic radical derived from an aromatic hydrocarbon by removal of one hydrogen, and includes any monocyclic, bicyclic or polycyclic carbon ring of up to 7 members in each ring, wherein at least one ring is aromatic. These radicals may be optionally substituted with a hydroxy, epoxy, chloro, bromo, iodo, cyano, nitro, mercapto OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or lower alkyl, and/or be interrupted by oxygen or sulphur atoms, or by silano or dialkylsilicon groups.

Examples of such radicals may be independently selected from phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like. The term “arylene”, as used herein, relates to a bivalent radical aryl group as defined above. For example, an aryl group such as phenyl which would be represented as -Ph, becomes phenylene, -Ph-, when represented as an arylene. Other arylene groups should be understood accordingly.

For the avoidance of doubt, the reference to alkyl, alkenyl, alkynyl, aryl or aralkyl in composite groups herein should be interpreted accordingly, for example the reference to alkyl in aminoalkyl or alk in alkoxyl should be interpreted as alk or alkyl above etc.

The hybrid sol-gel composition may comprise water. The hybrid sol-gel composition may comprise water to hydrolyse the metal alkoxide precursor and/or organosilane precursor.

The hybrid sol-gel composition may be prepared by any suitable method. Suitable methods will be known to a person skilled in the art.

Suitably, the metal alkoxide precursor and/or organosilane precursor are caused to undergo hydrolysis and polycondensation to form a polymeric network in the sol-gel composition.

Suitably, the hybrid sol-gel composition may be formed from the mixture of a first and second precursor composition. For example, the first precursor composition may comprise one or more organosilane precursor as defined herein and, optionally, an aqueous solution of a strong acid, such as, for example, nitric acid, sulphuric acid and/or hydrochloric acid. Suitably, the first precursor composition may comprise one or more organosilane precursor as defined herein and an aqueous solution of a strong acid, such as, for example, nitric acid, sulphuric acid and/or hydrochloric acid. For the avoidance of doubt, by “strong acid”, and like terms, as used herein is meant an acid having a pKa of less than 5 (five). Suitably, the strong acid may be nitric acid. Typically, the use of a strong acid in the first precursor composition results in the at least partial hydrolysis of the organosilane precursor.

For example, the second precursor may comprise one or more metal alkoxide precursor as defined herein. Suitably, the second precursor may comprise one or more organically modified metal alkoxide complexes as defined herein.

Thus, there is also provided a method of preparing a hybrid sol-gel composition for use in forming a diaphragm for a pressure sensor, the method comprising the steps of:
(a) providing a first precursor composition comprising an organosilane precursor and an aqueous solution of a strong acid;
(b) providing a second precursor composition comprising a metal alkoxide precursor;
(c) contacting the first precursor composition and the second precursor composition to form a reaction mixture; and
(d) causing the reaction mixture to undergo hydrolysis for a period of time, T, to form the sol-gel composition.

Suitably, in step (a) the weight ratio of organosilane precursor to aqueous solution of a strong acid may be from 5 to 100%, such as from 10 to 50%, or even 25% (i.e. from 1:20 to 1:1, such as from 1:10 to 1:2, or even 1:4).

Step (d) may be carried out for any suitable period of time, T. Step (d) may be carried out for a period of time, T, of at least 30 minutes, such as at least 1, 2, 3, 4, 5, 6, 7, 8, 9, 10, 11 or 12 hours. Suitably, step (d) may be carried out for a period of time, T, of at least 24 hours.

Step (d) may be carried out under any suitable conditions. Suitably, step (d) may be carried out at pH from 4 to 9, such as from 6 to 8, such as from 6.5 to 7.5, or even at pH 7. Suitably, a pH of from 6 to 8, such as from 6.5 to 7.5, or even at pH 7, may be achieved via the addition of water, such as deionised water. Thus, suitably, water, such as deionised water, may be added during step (d).

Suitably, when water is added in step (d), the weight ratio of water to the reaction mixture may be from 1 to 50%, such as from 2 to 10%, or even 5% (i.e. from 1:100 to 1:2, such as from 1:50 to 1:10, or even 1:20).

The organosilane precursor(s) and metal alkoxide precursor(s) may be covalently linked in the hybrid sol-gel composition or the organosilane precursor(s) and metal alkoxide precursor(s) may be non-covalently linked in the hybrid sol-gel composition. Examples of non-covalent linkages include, but are not limited to, electrostatic interactions, such as ionic bonding or hydrogen bonding, or Van der Waals interactions. Suitably, the organosilane precursor(s) and metal alkoxide precursor(s) may be covalently linked in the hybrid sol-gel composition.

The hybrid sol-gel composition may have any suitable viscosity. The hybrid sol-gel composition may have a viscosity from 5 to 50 centipoise (cP), such as from 10 to 40 cP, such as from 15 to 30 cP, such as from 20 to 25 cP, or even 20 cP.

Suitably, the hybrid sol-gel film of the present invention is formed from the hybrid sol-gel composition defined herein. The hybrid sol-gel film may be formed from the hybrid sol-gel composition by any suitable method. For example, the hybrid sol-gel film may be formed by a method comprising the steps of:
(a) coating an aperture of a capillary with the hybrid sol-gel composition as defined herein; and
(b) curing the hybrid sol-gel composition to form the hybrid sol-gel film.

Suitably, the capillary may be a glass capillary or a quartz capillary.

The capillary may further comprise a fibre, such as an optical fibre. Suitably, the capillary may be coated at a first end of the glass capillary with the hybrid sol-gel composition and a fibre, such as an optical fibre, may be provided at the second end of the capillary.

Suitably, the hybrid sol-gel composition may be diluted with an alcohol prior to it being coated on an end portion of a capillary. The alcohol may be any suitable alcohol, such as methanol, ethanol, propanol and/or butanol, for example. Suitably, the alcohol may comprise ethanol. The hybrid sol-gel composition may be diluted by any suitable factor. For example, the hybrid sol-gel composition may be diluted by 20 vol %, such as 30, 40, 50. 60, 70, 80, 90 or 95 vol %. For the avoidance of doubt, by ‘diluted by 20 vol %’, for example, is meant that the hybrid sol-gel composition forms 80 vol % of the diluted solution and the alcohol, for example, forms 20 vol % of the diluted solution.

However, alternatively, the hybrid sol-gel may not be diluted, i.e. may be used without dilution.

The aperture of the capillary may be at any suitable position on said capillary. For example, the aperture may be at the end of the capillary or may be on the side of capillary.

Suitably, the aperture may be at the end of the capillary.

Thus, suitably, the hybrid sol-gel film may be formed by a method comprising the steps of:
(a) coating an end portion of a capillary with the hybrid sol-gel composition as defined herein; and
(b) curing the hybrid sol-gel composition to form the hybrid sol-gel film.

The capillary may be coated with the hybrid sol-gel composition by any suitable method. Suitable methods will be known to a person skilled in the art. For example, the capillary may be dipped into the hybrid sol-gel solution, for example, to a depth of 2 centimetres (cm). It will be appreciated by a person skilled in the art that the depth may vary depending on the total length of the capillary. When the end portion of the capillary are coated with the hybrid sol-gel composition by dipping, the capillary may be withdrawn from the hybrid sol-gel composition at any suitable rate. The rate may be predetermined so as to produce a diaphragm having the appropriate properties. When the end portion of the capillary are coated with the hybrid sol-gel composition by dipping, the capillary may be withdrawn from the hybrid sol-gel composition at a rate of at least 10 millimetres/minute (mm/min), such as at least 15, 20, 25, 30, 35, 40, 45, 50, 60, 70. 80, 90, 100, 200, 300, 400 or 500 mm/min.

Suitably, the capillary may be withdrawn from the hybrid sol-gel composition at a rate of at least 40 millimetres/minute (mm/min).

Suitably, the capillary may be withdrawn from the hybrid sol-gel composition at a rate of from 40 to 500 millimetres/minute (mm/min).

It will be appreciated by a person skilled in the art that the rate at which the capillary is withdrawn from the hybrid sol-gel solution may vary depending on the dilution of the hybrid sol-gel composition and the film thickness of the hybrid sol-gel film which is to be achieved.

Withdrawing the capillary from the hybrid sol-gel composition suitably forms a film (or membrane) of the hybrid sol-gel composition over the aperture of the capillary.

In some examples, a specific volume of the hybrid sol-gel may be deposited onto the end face of the capillary or onto an existing diaphragm, which may allow surface/surface interaction-related forces to form the sol-gel diaphragm.

In step (b), the hybrid sol-gel composition is cured. The hybrid sol-gel composition may be cured by any suitable method. Suitable methods will be known to a person skilled in the art. For example, the hybrid sol-gel composition may be thermally cured, may be chemically cured or may be cured by radiation such as, for example, by infrared or UV. Suitably, the hybrid sol-gel composition may be thermally cured. The hybrid sol-gel composition may be thermally cured at any suitable temperature for any suitable period of time. For example, the hybrid sol-gel composition may be cured at 90° C. for 240 minutes. Alternatively, the hybrid sol-gel composition may be cured at 100° C. for 120 minutes, or 120° C. for 60 minutes, for example.

Suitably, curing the hybrid sol-gel composition forms the hybrid sol-gel film of the present invention.

The capillary may be coated with the hybrid sol-gel composition once or multiple times. For example, the capillary may be coated with the hybrid sol-gel once or may be coated twice, three times, four times etc. Suitably, the hybrid sol-gel composition is cured in between each coating step. Advantageously, coating the capillary with the hybrid sol-gel composition multiple times may enable the properties of the diaphragm to be optimised.

In certain embodiments, the hybrid sol-gel composition may be coated over another diaphragm, suitably formed from a different material to the hybrid sol-gel film such as, for example, a polymer diaphragm, carbon film, etc. Advantageously, coating the hybrid sol-gel composition over another diaphragm, suitably formed from a different material to the hybrid sol-gel film, may result in a diaphragm that has a flatter inner surface resulting in improved reflection of light.

Thus, according to a second aspect of the present invention there is provided a process for the manufacture of a diaphragm for a pressure sensor, the diaphragm comprising a hybrid sol gel film, the method comprising the steps of:
(a) providing a hybrid sol-gel composition formed by a process comprising the steps of:
   (i) providing a first precursor composition comprising an organosilane precursor and an aqueous solution of a strong acid;
   (ii) providing a second precursor composition comprising a metal alkoxide precursor;
   (iii) contacting the first precursor composition and the second precursor composition to form a reaction mixture; and
   (iv) causing the reaction mixture to undergo hydrolysis for a period of time, T, to form the sol-gel composition;
(b) coating an aperture of a capillary with the hybrid sol-gel composition produced in step (a); and
(c) curing the hybrid sol-gel composition to form the hybrid sol-gel film.

Suitably, the capillary may further comprise a fibre, such as an optical fibre. Suitably, the capillary may be coated at a first end of the capillary with the hybrid sol-gel composition and a fibre, such as an optical fibre, may be provided at the second end of the capillary.

Thus, suitably the process for the manufacture of a diaphragm for a pressure sensor, the diaphragm comprising a hybrid sol gel film, the method comprises the steps of:
(a) providing a hybrid sol-gel composition formed by a process comprising the steps of:
   (i) providing a first precursor composition comprising an organosilane precursor and an aqueous solution of a strong acid;
   (ii) providing a second precursor composition comprising a metal alkoxide precursor;
   (iii) contacting the first precursor composition and the second precursor composition to form a reaction mixture; and
   (iv) causing the reaction mixture to undergo hydrolysis for a period of time, T, to form the sol-gel composition;
(b) coating an end portion of a capillary with the hybrid sol-gel composition produced in step (a); and
(c) curing the hybrid sol-gel composition to form the hybrid sol-gel film.

Advantageously, when a fibre, such as an optical fibre, is present, the use of the method according to the second aspect of the present invention means that a layer of the hybrid sol-gel film typically coats the capillary and the junction between the capillary and fibre, such as an optical fibre. This may provide increased mechanical strength. Increased mechanical strength is an advantage when the capillary, fibre and hybrid sol-gel film are used in a pressure sensor.

The method may be controlled to provide a desired thickness of hybrid sol-gel film, suitably, to provide a thickness of hybrid sol-gel film such that the hybrid sol-gel film is suitable for use as a diaphragm in a pressure sensor. For example, the capillary may be withdrawn from the hybrid sol-gel composition at a rate that is controlled to provide a desired thickness of hybrid sol-gel film. For example, the dilution of the hybrid sol-gel composition, for example, with ethanol may be controlled to provide a desired thickness of hybrid sol-gel film.

The inorganic and organic components may be covalently linked in the hybrid sol-gel film or the inorganic and organic components may be non-covalently linked in the hybrid sol-gel film. Examples of non-covalent linkages include, but are not limited to, electrostatic interactions, such as ionic bonding or hydrogen bonding, or Van der Waals interactions. Preferably, the inorganic and organic components may be covalently linked in the hybrid sol-gel film. Advantageously, the use of a sol-gel film wherein the inorganic and organic components are covalently linked in the hybrid sol-gel film results in a sol-gel film that may have stronger mechanical properties Advantageously, the use of a sol-gel film wherein the inorganic and organic components are covalently linked in the hybrid sol-gel film results in a sol-gel film that may have stronger mechanical properties.

The hybrid sol-gel film according to any aspect of the present invention may have any suitable film thickness. Suitably, the hybrid sol-gel film may have a film thickness from 0.5 to 200 micrometres (μm), such as from 1 to 100 μm, such as from 1 to 50 μm, such as from 1 to 40 μm, such as from 1 to 30 μm, such as from 1 to 25 μm, such as from 1 to 20 μm, such as from 1 to 15 μm, such as from 1 to 10 μm, or even from 2 to 10 μm.

Suitably, the hybrid sol-gel film may have a film thickness from 2 to 100 μm.

Suitably, the hybrid sol-gel film may have a film thickness from 2 to 50 μm.

Suitably, the hybrid sol-gel film may have a film thickness from 2 to 10 μm.

The diaphragm of the present invention may be used in a sensor. Suitably, the pressure sensor may comprise an optical fibre, the diaphragm according to the first aspect of the present invention, and a wall defining a cavity between an end face of the optical fibre and the diaphragm.

Thus, according to a third aspect of the present invention, there is provided a pressure sensor comprising an optical fibre, a diaphragm, and a wall defining a cavity between an end face of the optical fibre and the diaphragm, wherein the diaphragm is configured to deflect under a difference between a pressure in the cavity and a pressure external to the sensor, and wherein the diaphragm comprises a hybrid sol-gel.

According to a fourth aspect of the present invention there is provided a pressure sensor comprising an optical fibre, a diaphragm, and a wall defining a cavity between an end face of the optical fibre and the diaphragm, wherein the diaphragm is configured to deflect under a difference between a pressure in the cavity and a pressure external to the sensor, and wherein the diaphragm comprises a hybrid sol-gel manufactured by process according to the second aspect of the present invention.

Suitable features of the third and/or fourth aspects of the present invention are as defined in relation to the first and/or second aspects of the present invention.

The pressure sensor may be any suitable pressure sensor. For example, the pressure sensor may be an extrinsic Fabry-Perot interferometric (EFPI) pressure sensor.

Suitable pressure sensors include, but are not limited to, those disclosed in US patent applications US 2018/0136055, US 2015/0077736 and US 2011/0190640, the entire contents of which are fully incorporated herein by reference.

As used herein, unless otherwise expressly specified, all numbers such as those expressing values, ranges, amounts or percentages may be read as if prefaced by the word “about”, even if the term does not expressly appear. Also, any numerical range recited herein is intended to include all sub-ranges subsumed therein.

Singular encompasses plural and vice versa. For example, although reference is made herein to “a” hybrid sol-gel, “a” metal alkoxide, “an” organosilane material, “an” organic component, “an” inorganic component, and the like, one or more of each of these and any other components can be used.

As used herein, including, for example and like terms means including for example but not limited to. Additionally, although the present invention has been described in terms of “comprising”, the articles, materials, methods and compositions detailed herein may also be described as “consisting essentially of” or “consisting of”.

All of the features contained herein may be combined with any of the above aspects and in any combination.

### BRIEF DESCRIPTION OF DRAWINGS

For a better understanding of the invention, and to show how embodiments of the same may be carried into effect, reference will now be made, by way of example only, to the following experimental data and accompanying drawings, in which:

FIG. 1 is a cross-sectional view of an example pressure sensor according to the present invention.

### DESCRIPTION OF EMBODIMENTS

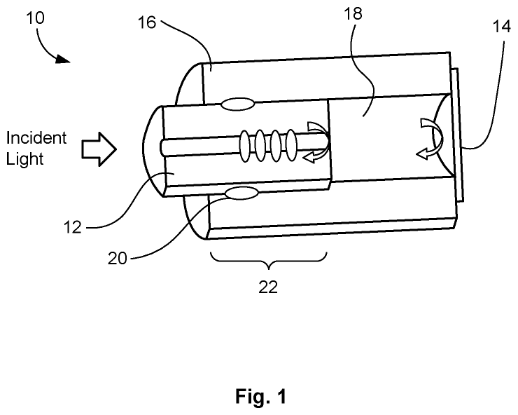

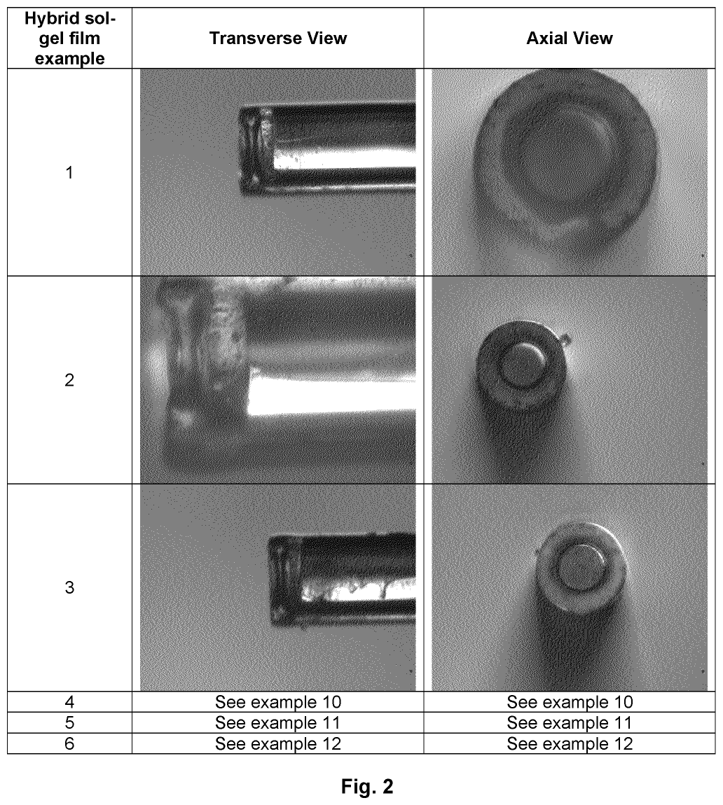

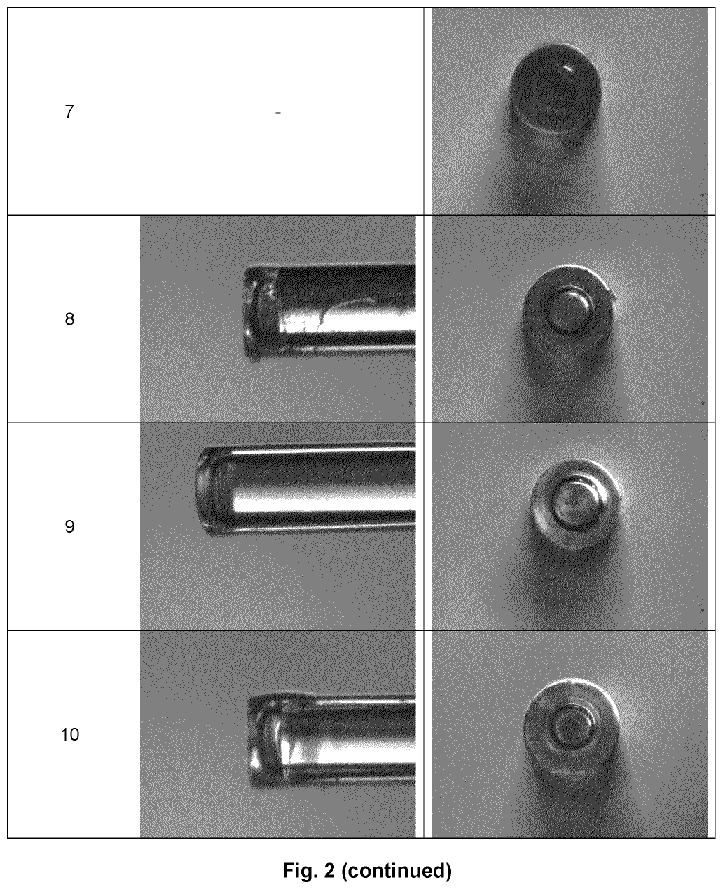

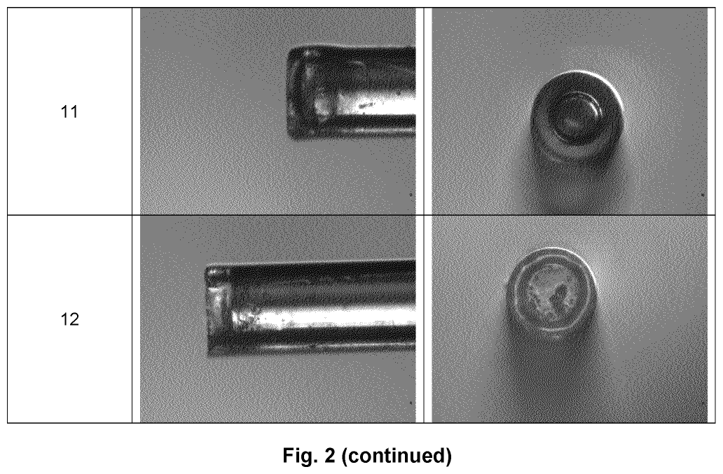

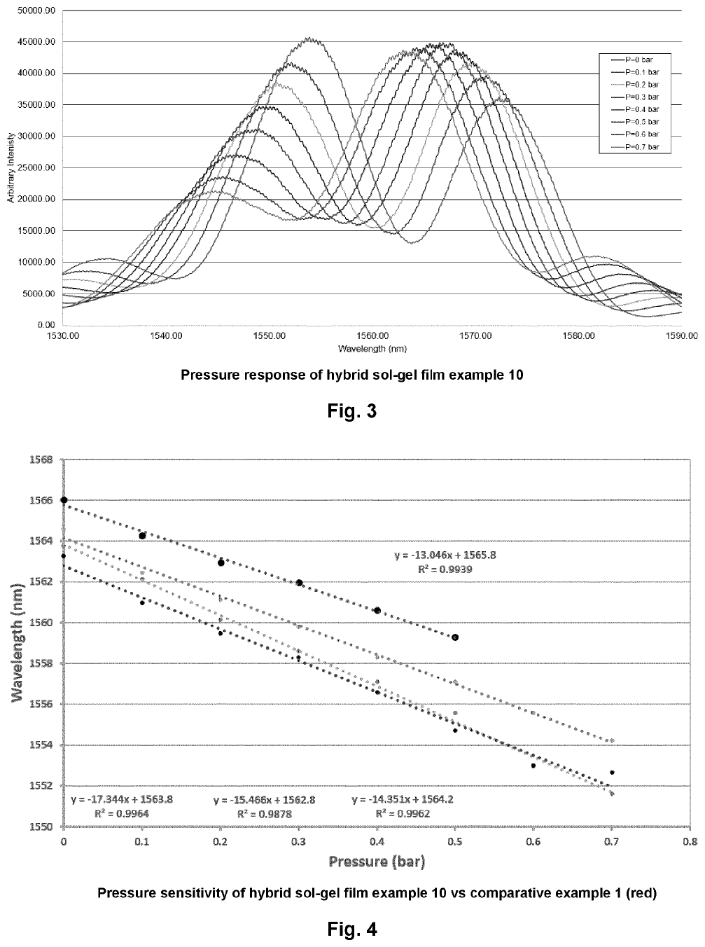

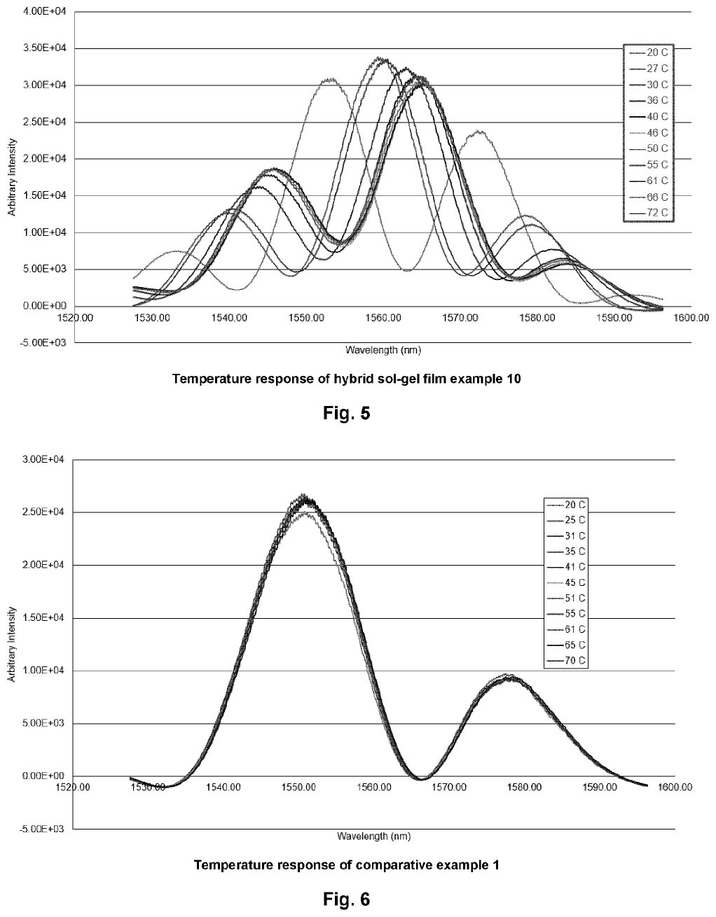

An EFPI sensor 10 according to the present invention, shown in FIG. 1, comprises an optical fibre 12, a diaphragm 14 and a capillary 16, for example a glass capillary. The diaphragm 14 is provided at a first end of the capillary 16, whilst the optical fibre 12 is provided in a second end of the glass capillary, thereby defining a cavity 18 within the capillary between an end face of the optical fibre 12 and the diaphragm 14.

The optical fibre 12 is a single mode fibre. The optical fibre 12 is fixed in place by a fusion splice 20, such that it extends partially within the capillary.

Applied pressure causes a deflection of the diaphragm 14, thereby modulating the length of the cavity 18. In some examples, the optical fibre 12 comprises an in-fibre Bragg grating (FBG) 22, which is used as a reference sensor to eliminate temperature cross-sensitivity of the EFPI pressure sensor 10.

An example method of fabricating the EFPI sensor comprises inserting a single mode optical fibre into a capillary having a 133 μm inner diameter and 220 μm outer diameter. The capillary has a length of 5 to 10 cm. The capillary is then fused with the optical fibre using a fusion splicer, providing a seal between the optical fibre and capillary. After fusion of the capillary with the optical fibre, the capillary may be cleaved using a manual scriber or cleaver, such that the length between the end of the capillary and the end face of the single mode fibre is 1 to 2 mm.

The capillary is then polished, manually or using a polishing machine, with different grit-size polishing paper, so that the length between the end of the capillary and the end face of the single mode fibre is 40 to 80 μm. The length between the end of the capillary and the end face of the single mode fibre can be monitored using a magnified optical microscope or an optical spectrum analyser.

The diaphragm 14 is formed from a hybrid sol-gel film according to the present invention.

The hybrid sol-gel film forms the diaphragm at the end of the capillary, as shown in FIG. 1. In an example, the hybrid sol-gel film wraps around the first end of the capillary, and thereby also extends around the outer cylindrical surface of the capillary along at least part of the length of the capillary, as shown in FIG. 2.

As illustrated in FIG. 1, incident light is reflected within the EFPI pressure sensor 10 at the end face of the optical fibre 12 and at the inside and outside surfaces of the diaphragm 14. All three reflections propagate back through the optical fibre 12, generating interference fringes which can be expressed by the following equation (1):

$$I ( λ , L ) = {A}_{1}^{2} + {A}_{2}^{3} + {A}_{3}^{2} - 2 {A}_{1} {A}_{2} cos ( \frac{4 π {L}_{C}}{λ} ) + 2 {A}_{3} {A}_{1} cos ( \frac{4 π ( {L}_{C} + nd )}{λ} ) - 2 {A}_{2} {A}_{3} cos ( \frac{4 π nd}{λ} ) \qquad ( 1 )$$

In equation (1), the first and second cosine terms describes the interference between the end face of the optical fibre 12 and the inner and outer surfaces of the diaphragm 14 respectively. The third cosine term describes the interference between the inner and outer surface of the diaphragm 14. A1, A2 and A3 are the amplitudes of the reflected light at the end face of the optical fibre 12 and the inside and outside surface of the diaphragm 14; n is the refractive index of the diaphragm 14; L_{c} is the length of the air cavity 18 between the end face of the optical fibre 12 and the inside surface of the diaphragm 14; d is the thickness of the diaphragm 14 and λ is the optical wavelength. The length L_{c} of the air cavity 18 changes when the diaphragm 14 deflects as a result of a pressure difference between a pressure inside the cavity 18 and outside the sensor 10.

The change in pressure can be determined based on the change in the length of the air cavity 18. The change in length of the air cavity ΔL_{P} due to the static pressure difference LAP at the centre of the diaphragm 14 may be expressed by equation (2):

$$Δ {L}_{P} = \frac{3 ( 1 - {μ}^{2} )}{16 {Eh}^{3}} \cdot {a}^{4} \cdot Δ P = {a}_{21} Δ P \qquad ( 2 )$$

In equation (2), h is the radius of the diaphragm, E is Young's Modulus, μ is the Poisson's ratio. The deflection of the diaphragm 14 thereby depends linearly on the pressure difference, and so the phase of the first and second cosine terms in equation (1) will also depend linearly on the pressure difference.

The thermal cross-sensitivity of the EFPI pressure sensor 10 is caused by the thermal expansion of all components, the diaphragm 14 and the air within the EFPI cavity 18. The change in length based on the change in pressure can be expressed by equation (3):

$$Δ {L}_{T} = ( {L}_{S} ( {α}_{C} - ≢ {0}_{SM} ) + {L}_{C} {α}_{SM} + \frac{{P}_{S}}{{T}_{S}} S ) Δ T = {a}_{22} Δ T \qquad ( 3 )$$

In equation (3), Ls is the distance between the diaphragm 14 and the optical fibre/capillary fusion splice 20, α_{c} and α_{SM} are the coefficients of thermal expansion (CTE) of the capillary 16 and the optical fibre 12 respectively. Pₛ and Tₛ are the pressure and temperature during sealing and S is the pressure sensitivity of the EFPI pressure sensor 10.

FBGs are simple, intrinsic sensing elements which have been extensively used for strain, temperature and pressure sensing. The standard FBG grating is formed as a regular variation in the refractive index of the core of a single-mode (SM) optical fibre. Chirped FBGs may also be used in certain examples where a particular response is desired. Chirped FBGs are typically characterised by a non-uniform modulation of the refractive index within the core of an optical figure. In normal operation a standard FBG causes light propagating in the optical SM fibre core of a particular wavelength (the Bragg wavelength λ_{B}) to be reflected back. The Bragg wavelength is defined by equation (4):

λ_{B}=2n_{eff}Λ (4)

n_{eff} is the refractive index of the core material and Λ is the period of the grating. All other wavelengths are transmitted in the normal manner through the fibre. The sensing function of a FBG derives from the sensitivity of the refractive index and grating period to externally applied mechanical or thermal perturbation. It is experienced by the FBG through altering the reflected Bragg wavelength λ_{B}.

In the EFPI pressure sensor 10, the FBG 22 is fully encapsulated in the capillary 16. This keeps the FBG 22 strain and pressure free and hence it is only sensitive to temperature. The temperature sensitivity occurs through the effect on the induced refractive index change and on the thermal expansion coefficient of the SM fibre. The Bragg wavelength shift Δλ_{B,T} due to temperature change ΔT is expressed by equation (5):

$${Δλ}_{B , T} = {λ}_{B} ( α + \frac{1}{{n}_{eff}} {dn}_{effdT} ) Δ T = {a}_{12} Δ T \qquad ( 5 )$$

In equation (5), dn_{eff}/dT is the thermo optic coefficient.

Using the temperature and pressure coefficients form both sensing units a matrix can be constructed as:

$$[ \begin{matrix}{Δλ}_{B} \\ Δ L\end{matrix} ] = [ \begin{matrix}0 & {a}_{12} \\ - a21 & {a}_{22}\end{matrix} ] [ \begin{matrix}Δ P \\ Δ T\end{matrix} ] \qquad ( 6 )$$

The inversion of the matrix can be used to discriminate between the pressure ΔP and temperature ΔT information from the FBG and EFPI pressure sensor.

Exemplary hybrid sol-gel films, as used as the diaphragm 14 in the pressure sensor 10 of FIG. 1, are provided below.

### EXAMPLES

### Example 1

### Preparation of Hybrid Sol-Gel Composition Example 1

A first precursor composition was prepared by mixing 15 grams (g) 3-methacryloxypropyltrimethoxysilane (MAPTMS) (available from Sigma Aldrich) and 0.8 g of 0.1 M HNO₃. The mixture was stirred at room temperature for 45 minutes.

A second precursor composition was prepared by mixing 7.1 g of a 70 vol % solution of zirconium (IV) n-propoxide (Zr(OPr)₄) (available from Sigma Aldrich) in propanol and 1.2 g methacrylic acid (MAA) (available from Sigma Aldrich). The mixture was stirred at room temperature for 45 minutes.

Then, the first precursor composition was slowly added to the second precursor composition over a time period of 5 minutes. After addition was complete, the reaction was allowed to proceed for 5 minutes before a neutral hydrolysis was performed by adding 1.3 g deionised water dropwise to the reaction mixture. The reaction mixture was then stirred at room temperature for 24 hours. The resultant hybrid sol-gel composition was clear and transparent and had a viscosity of about 20 cP.

### Preparation of Hybrid Sol-Gel Composition Example 2

A first precursor composition was prepared by mixing 10 grams (g) 3-methacryloxypropyltrimethoxysilane (MAPTMS) (available from Sigma Aldrich), 4.45 g 3-triethoxysilypropylamine (APTES) and 0.8 g of 0.1 M HNO₃. The mixture was stirred at room temperature for 20 minutes

A second precursor composition was prepared by mixing 3.5 g titanium isopropoxide (available from Sigma Aldrich) and 0.6 g acetic acid (AA) (available from Sigma Aldrich). The mixture was stirred at room temperature for 45 minutes.

Then, the first precursor composition was slowly added to the second precursor composition over a time period of 10 minutes. After addition was complete, the reaction was allowed to proceed for 5 minutes before a neutral hydrolysis was performed by adding 1.1 g of deionised water dropwise to the reaction mixture. The reaction mixture was then stirred at room temperature for 24 hours. The resultant hybrid sol-gel composition was clear and transparent and had a viscosity of about 30 cP.

### Example 2

### Preparation of Hybrid Sol-Gel Film Examples 1-9

The first end of the glass capillary having an optical fibre provided at the second end of the glass capillary, as shown in FIG. 1, was held in a fibre clamp with 50 mm of the first end of the glass capillary extruded. The first end of the glass capillary was then dipped into the hybrid sol-gel composition prepared in example 1 at various dilutions as provided in table 1. The first end of the glass capillary was dipped into the hybrid sol-gel solution to a depth of 20 mm. The glass capillary was held in the hybrid sol-gel composition for 60 seconds. After this time, the glass capillary was withdrawn from the hybrid sol-gel solution at the rate provided in Table 1.

The coated glass capillaries where then removed from the fibre clamp and suspended in a drying chamber. The drying chamber was then heated from room temperature to 110° C. Once this temperature was reached, the glass capillaries were held in the drying chamber for 30 minutes to thermally cure the hybrid sol-gel compositions. Curing of the hybrid sol-gel compositions formed hybrid sol-gel films which could then be used as a diaphragm in the pressure sensor of FIG. 1.

TABLE 1
Preparation of hybrid sol-gel film examples 1-9

| | | Rate of withdrawal |
|---|---|---|
| Hybrid sol-gel film example | Dilution (%) | (mm/min) |
| 1 | 20 | 40 |
| 2 | 40 | 40 |
| 3 | 50 | 40 |
| 4 | 80 | 40 |
| 5 | 95 | 40 |
| 6 | 0 (pure) | 40 |
| 7 | 0 (pure) | 40 |
| 8 | 0 (pure) | 40 |
| 9 | 0 (pure) | 100 |

### Preparation of Hybrid Sol-Gel Film Examples 10-12

The first end of the glass capillaries having the hybrid sol-gel films of examples 4, 5 and 6 thereon were re-dipped into the undiluted, i.e. pure, hybrid sol-gel composition of example 1 according to the same process as described above for the preparation of hybrid sol-gel film examples 1-9. The rate at which the glass capillaries were withdrawn from the hybrid sol-gel composition are provided in Table 2.

TABLE 2
Preparation of hybrid sol-gel film examples 10-12

| | | Rate of withdrawal |
|---|---|---|
| Hybrid sol-gel film example | Dilution (%) | (mm/min) |
| 10 | 0 (pure) | 40 |
| 11 | 0 (pure) | 20 |
| 12 | 0 (pure) | 100 |

The resultant hybrid sol-gel films were tested according to the following test methods.

Observation of hybrid sol-gel films: the transverse and axial views of the cured hybrid sol-gel films were observed visually under a microscope. The results are shown in FIG. 2.

Pressure and temperature responses: the optical properties of the hybrid sol-gel films were tested to determine if they were suitable for use as a diaphragm in an EFPI based on the returned spectral response from the EFPI. The hybrid sol-gel films were tested against a standard silica diaphragm as a reference (i.e. comparative example 1). The results of the pressure and temperature response for hybrid sol-gel example 12 and comparative example 1 are shown in FIGS. 3 to 6, in which FIG. 3 shows the pressure response of hybrid sol-gel example 12, FIG. 4 shows the pressure sensitivity of hybrid sol-gel example 12 versus comparative example 1, FIG. 5 shows the temperature response of hybrid sol-gel example 12 and FIG. 6 shows the temperature response of comparative example 1.

The results show that the hybrid sol-gel films of the inventive examples are generally of a similar construction and the quality of the hybrid sol-gel films are of a good quality with minimal artefacts. The hybrid sol-gel films also have a relatively uniform surface finish.

The results also show that the hybrid sol-gel films of the present invention are more sensitive that the comparative silica diaphragm.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A diaphragm for a pressure sensor, the diaphragm comprising a hybrid sol-gel film.

2. A diaphragm according to claim 1, wherein the hybrid sol-gel film is formed from a hybrid sol-gel composition formed from at least one metal alkoxide precursor and at least one organosilane precursor.

3. A diaphragm according to claim 2, wherein the metal alkoxide precursor is according to formula M(OR)ₓ and/or formula M(OR)ₓ and/or formula M(OR)_{X-n}(R′)ₙ, wherein M is a metal atom, each R is independently an alkyl group, each R′ is independently an organic group, X is the valence of the metal atom, M, and n is from 1 to X−1 (X minus 1).

4. A diaphragm according to claim 3, wherein the metal, M, is zirconium (Zr).

5. A diaphragm according to claim 4, the metal alkoxide precursor comprises zirconium butoxide (Zr(OBu)₄) and/or zirconium propoxide (Zr(OPr)₄).

6. A diaphragm according to claim 3, wherein R′ is derived from pivalic acid, acetic acid, (alk)acrylic acid, alkyl(alk)acylate or combinations thereof.

7. A diaphragm according to claim 6, wherein R′ is derived from (alk)acrylic acid, alkyl(alk)acylate or combinations thereof.

8. A diaphragm according to claim 1, wherein the organosilane precursor is according to formula R¹₄₋ₓSi(OR²)ₓ, wherein each R¹ is independently a substituted or unsubstituted alkyl group, each R² is independently an alkyl group and X is 1-4.

9. A diaphragm according to claim 8, wherein the organosilane precursor comprises methacryloxypropyltrimethoxysilane (MAPTMS).

10. A diaphragm according to claim 2, wherein the hybrid sol-gel composition is prepared by a method comprising the steps of:
(a) providing a first precursor composition comprising an organosilane precursor and an aqueous solution of a strong acid;
(b) providing a second precursor composition comprising a metal alkoxide precursor;
(c) contacting the first precursor composition and the second precursor composition to form a reaction mixture; and
(d) causing the reaction mixture to undergo hydrolysis for a period of time, T, to form the sol-gel composition.

11. A diaphragm according to claim 1, wherein the hybrid sol-gel film has a film thickness from 2 to 100 μm.

12. A process for the manufacture of a diaphragm for a pressure sensor according to claim 1, the method comprising the steps of:
(a) providing a hybrid sol-gel composition formed by a process comprising the steps of:
(i) providing a first precursor composition comprising an organosilane precursor and an aqueous solution of a strong acid;
(ii) providing a second precursor composition comprising a metal alkoxide precursor;
(iii) contacting the first precursor composition and the second precursor composition to form a reaction mixture; and
(iv) causing the reaction mixture to undergo hydrolysis for a period of time, T, to form the sol-gel composition;
(b) coating an end portion of a capillary with the hybrid sol-gel composition produced in step (a); and
(c) curing the hybrid sol-gel composition to form the hybrid sol-gel film.

13. The process according to claim 12, wherein the capillary is a glass capillary.

14. A pressure sensor comprising an optical fibre, a diaphragm according to claim 1, and a wall defining a cavity between an end face of the optical fibre and the diaphragm, wherein the diaphragm is configured to deflect under a difference between a pressure in the cavity and a pressure external to the sensor.

15. A pressure sensor comprising an optical fibre, a diaphragm manufactured according to the process of claim 12, and a wall defining a cavity between an end face of the optical fibre and the diaphragm, wherein the diaphragm is configured to deflect under a difference between a pressure in the cavity and a pressure external to the sensor.
